(19) United States
(12) Patent Application Publication
(10) Pub. No.: US 2012/0215966 A1
(43) Pub. Date: Aug. 23, 2012

(54) DISK ARRAY UNIT AND CONTROL METHOD THEREOF

(75) Inventor: Akihiko FUKUYAMA, Tokyo (JP)

(73) Assignee: NEC Corporation, Tokyo (JP)

(21) Appl. No.: 13/398,707

(22) Filed: Feb. 16, 2012

(30) Foreign Application Priority Data
Feb. 22, 2011 (JP) 2011-035995

(51) Int. Cl. G06F 12/00

(52) U.S. Cl. 711/103; 711/E12.008

(57) ABSTRACT

The invention proposes a disk array unit capable of improving access performance. The disk array unit according to the invention includes: a plurality of semiconductor memories for storing data received from a host computer; a plurality of disk devices for storing the data; and a controller that redundantly configures the semiconductor memories and the disk devices by using a RAID 1 and controls reading of the data from the semiconductor memories or the disk devices. The controller reads the data from the semiconductor memories, and transmits the data, which are read from the semiconductor memories, to the host computer, when the semiconductor memories and the disk devices are in a normal state, or when the semiconductor memories are in an abnormal state and data areas of the semiconductor memories in which the data are stored are completely recovered.

### CROSS-REFERENCES

This application is based upon and claims the benefit of priority from Japanese patent application No. 2011-035995, filed on Feb. 22, 2011, the disclosure of which is incorporated herein in its entirety by reference.

### BACKGROUND

The present invention relates to a disk array unit and a control method thereof.

In a conventional disk array unit, an SSD (Solid State Drive) that provides faster random access time than a HDD (Hard Disk Drive) is used in place of the HDD in order to improve the disk access performance.

For example, Patent Publication JP-A-2009-223355 discloses a control system as a disk array unit that uses the SSD. The control system of Patent Publication JP-A-2009-223355 performs the mirroring of a hard disk and a silicon disk in response to a write access request from a computer system.

The problem in a recent exponential increase in the volume of hard disk is that, when a failure occurs in any of large-volume disk drives constructing a RAID (Redundant Array of Independent Disks), it can take several days in a recovery work, thereby not being able to improve the access performance during the recovery work.

### SUMMARY

The invention was contrived in view of the above circumstances. An exemplary object of the invention provides a disk array unit and a control method thereof, which are capable of improving access performance.

In order to achieve the object described above, one aspect of a disk array unit according to the invention is a disk array unit having: a plurality of semiconductor memories for storing data received from a host computer; a plurality of disk devices for storing the data; and a controller that redundantly configures the semiconductor memories and the disk devices by using a RAID 1 and controls reading of the data from the semiconductor memories or the disk devices, wherein the controller reads the data from the semiconductor memories, and transmits the data, which are read from the semiconductor memories, to the host computer, when the semiconductor memories and the disk devices are in a normal state, or when the semiconductor memories are in an abnormal state and data areas of the semiconductor memories in which the data are stored are completely recovered.

In addition, one aspect of a control method of a disk array unit according to the invention is a control method of a disk array unit including: a plurality of semiconductor memories for storing data received from a host computer; a plurality of disk devices for storing the data; and a controller that redundantly configures the semiconductor memories and the disk devices by using a RAID 1 and controls reading of the data from the semiconductor memories or the disk devices, the control method having: a first step in which the controller reads the data from the semiconductor memories when the semiconductor memories and the disk devices are in a normal state, or when the semiconductor memories are in an abnormal state and data areas of the semiconductor memories in which the data are stored are completely recovered; and a second step in which the controller transmits the data, which are read from the semiconductor memories, to the host computer.

Configuring either one of the recording media as the disk devices can save the costs. Moreover, preferentially reading the data from the semiconductor memories can utilize the reading performance of a SSD while saving the costs. In addition, because the data are read from the semiconductor memories during a recovery work on the semiconductor memories or upon completion of the recovery work, the reading performance of the semiconductor memories can be utilized.

The invention can provide a disk array unit and a control method thereof, which are capable of improving access performance.

### DESCRIPTION OF THE DRAWINGS

FIG. 1 is a diagram showing an example of a configuration of a storage system;

FIG. 2 is a diagram showing an example of a conceptual diagram for illustrating a SSD/HDD-mixed RAID list; and

FIG. 3 is a flowchart showing procedures of a data reading process.

### EXEMPLARY EMBODIMENT

An exemplary embodiment of the invention is described hereinafter in detail with reference to the drawings. It should be noted that the invention is not limited thereto.

(Configuration)

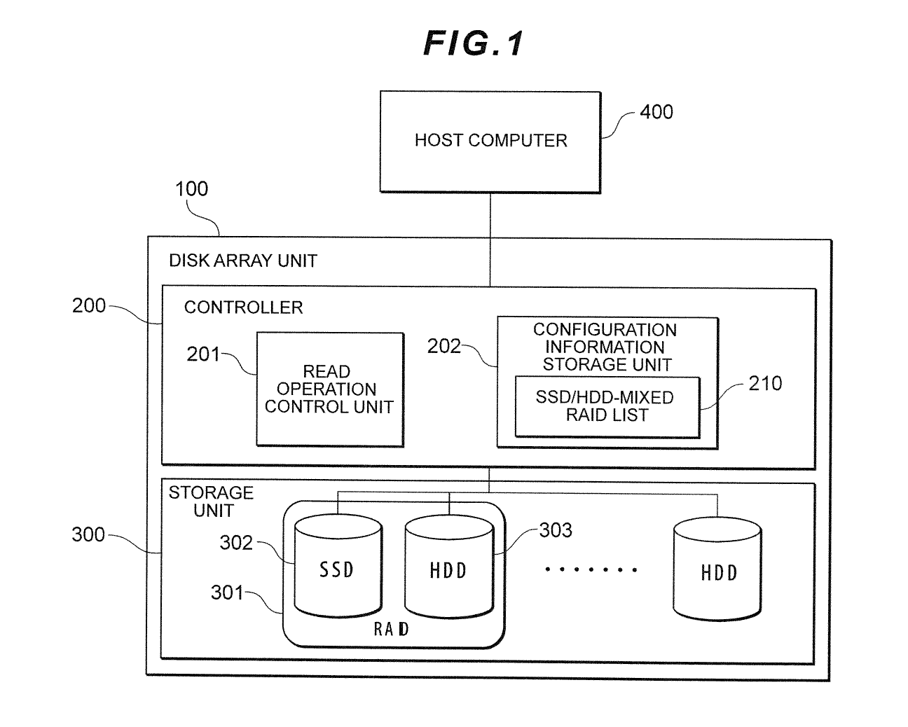

FIG. 1 is a diagram showing an example of a configuration of a storage system 1 according to the present embodiment. The storage system 1 has, for example, a host computer 400 and a disk array unit 100. The host computer 400 and the disk array unit 100 are connected to each other by a predetermined network, for example.

The host computer 400 is a computer apparatus that has, for example, a CPU (Central Processing Unit), an information processing resource such as a memory, an information input device, and an information output device. The host computer 400 transmits, for example, a write request to the disk array unit 100 and writes corresponding data into the disk array unit 100. The host computer 400 also transmits, for example, a read request to the disk array unit 100 and reads corresponding data from the disk array unit 100.

For example, a LAN (Local Area Network), a SAN (Storage Area Network), the Internet, a dedicated circuit, a public circuit and the like can be used appropriately as the predetermined network, depending on the situations.

The disk array unit 100 has, for example, a controller 200 and a storage unit 300. The disk array unit 100 has at least one controller 200. The controller 200 controls the entire disk array unit 100. The storage unit 300 has, for example, a plurality of semiconductor memories and a plurality of physical disk devices for storing data received from the host computer 400.

The controller 200 interprets various requests received from the host computer 400, and controls each component. The controller 200 also improves the reliability, availability and performance of the disk array unit 100 by performing RAID (Redundant Array of Inexpensive/Independent Disks) control on the semiconductor memories and the physical disk devices. In this case, the controller 200 sets one or more logical disks on physical storage areas (RAID groups) provided by the semiconductor memories and the physical disk devices. Then, when the host computer 400 designates an address of one of the logical disks, the controller 200 stores data in this logical disk in block unit of a predetermined size.

The controller 200 has, for example, a read operation control unit 201 and a configuration information storage unit 202. The read operation control unit 201 controls reading of data stored in the storage unit 300. A SSD/HDD-mixed RAID list 210 is stored in the configuration information storage unit 202.

The storage unit 300 has, for example, RAIDs 301 of a RAID level 1. Each of the RAIDs 301 has a SSD 302 and a HDD 303. In other words, the SSD 302 and the HDD 303 are mirrored. Each RAID 301 with the SSD 302 and the HDD 303 is also called “SSD/HDD-mixed RAID.”

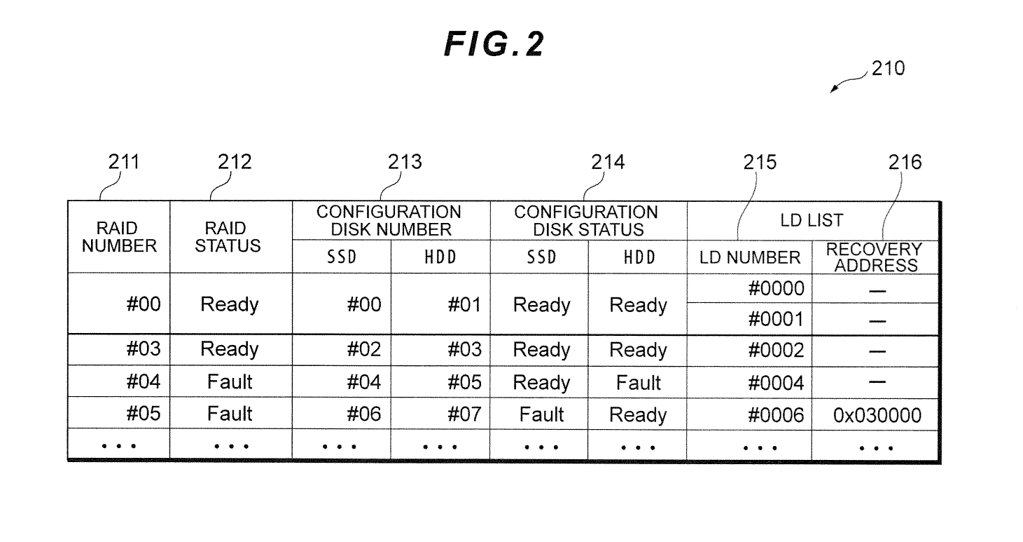

FIG. 2 is a diagram showing an example of a conceptual diagram for illustrating the SSD/HDD-mixed RAID list 210. The SSD/HDD-mixed RAID list 210 correlates RAID numbers 211 and RAID statuses 212 of all of the SSD/HDD-mixed RAIDs of the disk array unit 100, configuration disk numbers 213, which are numbers assigned to the physical disk devices configuring each RAID 301, configuration disk statuses 214, which are statuses of the physical disk devices, LD numbers 215, which are numbers assigned to the logical disks of the RAIDs 301, and recovery addresses 216 of the logical disks.

When a failure occurs in the SSD 302 or the HDD 303, the recovery address 216 shows how much the failure is recovered. For instance, when the recovery address 216 is “0x030000,” it means that the logical disks (SSD 302 or HDD 303) “0x000000” to “0x030000” are recovered completely.

For example, in the RAID 301 having the RAID number “5,” the RAID status thereof is “Fault (abnormal),” the number of its SSD 302 is “6,” the number of its HDD 303 is “7,” the status of its SSD 302 is “Fault,” the status of its HDD 303 is “Ready (normal),” the LD number of the RAID 301 is “6,” and the recovery address of the corresponding logical disk is “0x030000.”

(Procedures of Data Reading Process)

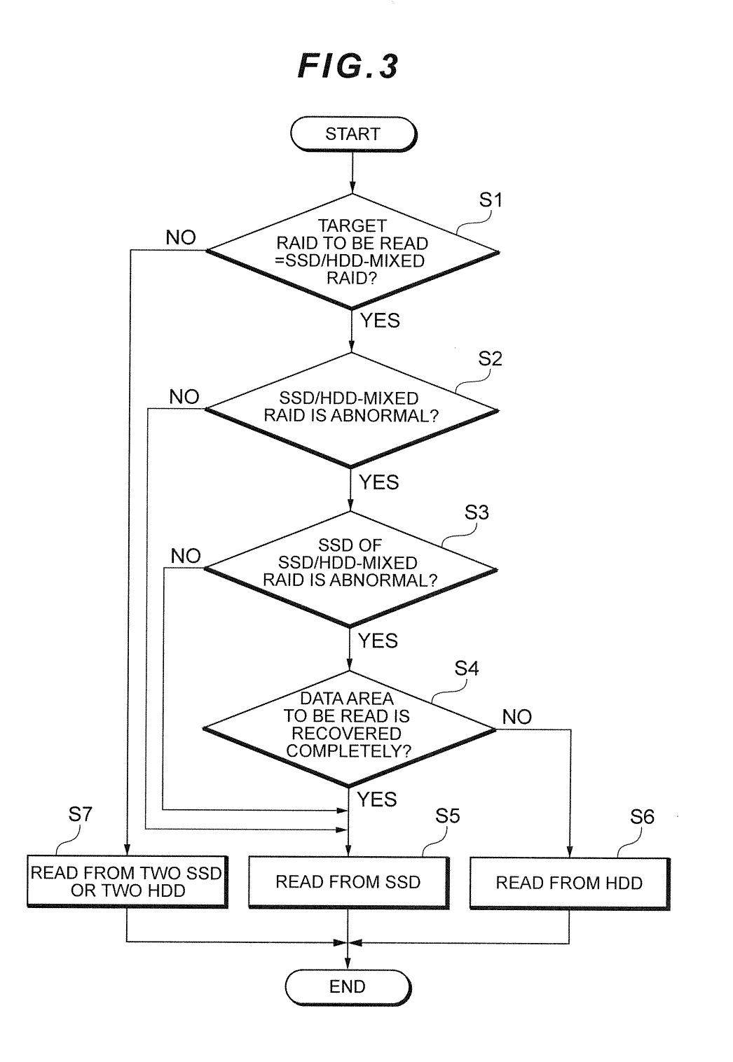

Next, operations of the storage system 1 according to the embodiment are described in detail. FIG. 3 is a flowchart showing procedures of a data reading process performed by the disk array unit 100 according to the embodiment.

For example, once the read operation control unit 201 receives a data read request from the host computer 400, the read operation control unit 201 starts the procedures of the data reading process, and specifies read target logical disks and RAIDs 301. The read operation control unit 201 then refers to the RAID numbers 211 of the SSD/HDD-mixed RAID list 210 held in the configuration information storage unit 202. Subsequently, the read operation control unit 201 determines whether a target RAID 301, from which the data are read, exists in the SSD/HDD-mixed RAID list 210 or not, and thereby determines whether this target RAID 301 is the SSD/HDD-mixed RAID (step S1). Note that the read target logical disks and RAIDs 301 may be specified by a host I/F control unit (not shown).

When the target RAID 301, from which the data are read, is not the SSD/HDD-mixed RAID (step S1: NO), it means that the target RAID 301 is a RAID 301 configured only by the SSD 302 or the HDD 303. Therefore, the read operation control unit 201 disperses loads from two SSDs 302 or two HHDs 303, and executes the data reading process to read the target data to the host computer 400 (step S7).

When, on the other hand, the target RAID 301, from which the data are read, is the SSD/HDD-mixed RAID (step S1: YES), the read operation control unit 201 refers to the RAID status numbers 212 of the SSD/HDD-mixed RAID list 210. Subsequently, the read operation control unit 201 determines whether the status of the target RAID 301 is abnormal or not (step S2).

When the status of the target RAID 301 is not abnormal (step S2: NO), the read operation control unit 201 reads the target data from the SSD 302 to the host computer 400 (step S5).

When, on the other hand, the status of the target RAID 301 is abnormal (step S2: YES), the read operation control unit 201 refers to the configuration disk numbers 213 and the configuration disk statuses 214 of the SSD/HDD-mixed RAID list 210. Subsequently, the read operation control unit 201 determines whether the status of the target SSD 302, from which the data are read, is abnormal or not (step S3).

When the status of the target SSD 302 is not abnormal (step S3: NO), the read operation control unit 201 reads the target data from the SSD 302 to the host computer 400 (step S5).

When, on the other hand, the status of the target SSD 302 is abnormal (step S3: YES), the read operation control unit 201 refers to the LD numbers 215 and the recovery addresses 216 of the SSD/HDD-mixed RAID list 210. Subsequently, based on the fact that the corresponding recovery address 216 is greater than the number assigned to the address in which the read target data are stored, the read operation control unit 201 determines whether or not the data area of the SSD 302, from which the data are read, is completely recovered (step S4).

When this data area of the SSD 302 in which the read target data are stored is completely recovered (step S4: YES), the read operation control unit 201 reads the read target data from the SSD 302 to the host computer 400 (step S5).

When the data area of the SSD 302 in which the read target data are stored is not completely recovered (step S4: NO), the read operation control unit 201 reads the target data from the HDD 303 to the host computer 400 (step S6).

Eventually, the read operation control unit 201 transmits the data read from the SSD 302 or the HDD 303, to the host computer 400 and ends the procedures of the data reading process.

(Operations and Effects)

As described above, in the disk array unit 100 of the embodiment, each of the RAIDs 301 has the SSD 302 and the HDD 303. When the status of the target RAID 301, from which the data are read, is not abnormal, or when the data area of the SSD 302 in which the read target data are stored is completely recovered, the read operation control unit 201 reads the target data from the SSD 302 to the host computer 400 and transmits the read data to the host computer 400.

Therefore, because one of the recording media is configured as the HDD 303 in the RAID 301 of the RAID level 1 that uses the SSD 302, the costs can be lowered. Moreover, preferentially reading the data from the SSDs 302 can utilize the reading performance of the SSDs 302 while saving the costs.

In addition, because the data are read from completely recovered sections of the SSDs 302 even during a recovery work on the SSDs 302, the reading performance of the SSDs 302 can be utilized.

The embodiment has described the RAID 301 of the RAID level 1 (mirroring), but the present invention is not limited thereto. The same effects can be realized in, for example, a triple mirror RAID with one SSD 302 and two HDD 303 or other types of RAIDs.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Part or all of the embodiment are described in the following additional notes but are not limited thereto.

(Additional Note 1)

A disk array unit having: a plurality of semiconductor memories for storing data received from a host computer; a plurality of disk devices for storing the data; and a controller that redundantly configures the semiconductor memories and the disk devices by using a RAID 1 and controls reading of the data from the semiconductor memories or the disk devices, wherein the controller reads the data from the semiconductor memories, and transmits the data, which are read from the semiconductor memories, to the host computer, when the semiconductor memories and the disk devices are in a normal state, or when the semiconductor memories are in an abnormal state and data areas of the semiconductor memories in which the data are stored are completely recovered.

(Additional Note 2)

A control method of a disk array unit including: a plurality of semiconductor memories for storing data received from a host computer; a plurality of disk devices for storing the data; and a controller that redundantly configures the semiconductor memories and the disk devices by using a RAID 1 and controls reading of the data from the semiconductor memories or the disk devices, the control method having: reading the data from the semiconductor memories when the semiconductor memories and the disk devices are in a normal state, or when the semiconductor memories are in an abnormal state and data areas of the semiconductor memories in which the data are stored are completely recovered; and transmitting the data, which are read from the semiconductor memories, to the host computer.

I (we) claim:

1. A disk array unit, comprising:
a plurality of semiconductor memories for storing data received from a host computer;
a plurality of disk devices for storing the data; and
a controller that redundantly configures the semiconductor memories and the disk devices by using a RAID 1 and controls reading of the data from the semiconductor memories or the disk devices,
wherein the controller reads the data from the semiconductor memories, and transmits the data, which are read from the semiconductor memories, to the host computer, when the semiconductor memories and the disk devices are in a normal state, or when the semiconductor memories are in an abnormal state and data areas of the semiconductor memories in which the data are stored are completely recovered.

2. A control method of a disk array unit including:
a plurality of semiconductor memories for storing data received from a host computer;
a plurality of disk devices for storing the data; and
a controller that redundantly configures the semiconductor memories and the disk devices by using a RAID 1 and controls reading of the data from the semiconductor memories or the disk devices,
the control method comprising:
reading the data from the semiconductor memories when the semiconductor memories and the disk devices are in a normal state, or when the semiconductor memories are in an abnormal state and data areas of the semiconductor memories in which the data are stored are completely recovered; and
transmitting the data, which are read from the semiconductor memories, to the host computer.
